(19) United States
(12) Patent Application Publication
(10) Pub. No.: US 2016/0332334 A1
(43) Pub. Date: Nov. 17, 2016

(54) HOT MELT MATERIAL PROCESSOR UTILIZING INSULATING NON-STICK UPPER SECTION

(71) Applicant: Ryan R. Hopkins, Reno, NV (US)

(72) Inventor: Ryan R. Hopkins, Reno, NV (US)

(73) Assignee: Moldman Systems LLC, Reno, NV (US)

(21) Appl. No.: 15/152,638

(22) Filed: May 12, 2016

Related U.S. Application Data
(60) Provisional application No. 62/160,414, filed on May 12, 2015.

(51) Int. Cl. B29B 13/02

(52) U.S. Cl. CPC B29B 13/022; B29K 2995/0013

(57) ABSTRACT

A thermal reservoir including a heating section and an upper section is provided. The upper section defines a storage cavity. The upper section is formed from an insulated, non-stick or insulated non-stick material. The upper section is fluidly connected to the heating section and upstream from the heating section for receiving material to be heated prior to the heating section.

### CROSS-REFERENCE TO RELATED PATENT APPLICATIONS

This patent application claims the benefit of U.S. Provisional Patent Application No. 62/160,414, filed May 12, 2015, the entire teachings and disclosure of which are incorporated herein by reference thereto.

### FIELD OF THE INVENTION

This invention generally relates to molding apparatuses or other apparatuses for dispensing material. More particularly, this invention relates to hot melt thermal reservoirs for molding apparatuses or material dispensing apparatuses.

### BACKGROUND OF THE INVENTION

Molding apparatuses or other systems for dispensing fluid materials often require heating the material to be molded or dispensed prior to molding a desired component or dispensing. This is particularly true when molding or dispensing using hot melt materials or other thermoplastic or thermoplastic like material. Molding apparatuses for molding using hot melt often include a thermal reservoir to heat and melt the material prior to molding or dispensing.

With reference to FIG. 1, when the level of material, e.g., hot melt material 10 decreases within the reservoir 12, a thin film 14 of melted material 10 will stick to and is left along the wall 16 of the reservoir 12. Because the wall 16 of the reservoir 12 is hot, e.g. for heating and melting the material 10 therein, the thin film 14 of material 10 is left to absorb large amounts of heat. This absorption of large amounts of heat results in rapid material degradation (e.g. char 18) of the thin film 14 of material 10.

When the material level is low, the thin film of material is also exposed to air which can also cause material degradation.

The present invention relates to improvements over the art in thermal reservoirs.

### BRIEF SUMMARY OF THE INVENTION

In one aspect, a thermal reservoir including a heating section and an upper section is provided. The upper section defines a storage cavity for storing material to be melted. The upper section is formed from an insulated non-stick material. The upper section is fluidly connected to the heating section and is upstream from the heating section for receiving material prior to the heating section.

In one embodiment, a thermal reservoir including a heating section and an upper section is provided. The upper section defines a storage cavity for storing material to be melted. The upper section is formed from an insulated material. The upper section is fluidly connected to the heating section and is upstream from the heating section for receiving material prior to the heating section.

In embodiments of the thermal reservoirs, the upper section is formed from polytetrafluoroethylene.

In embodiments of the thermal reservoirs and methods, the heating section is a finned portion defining one or more flow passages therethrough, the one or more flow passages being in fluid communication with the storage cavity.

In embodiments of the thermal reservoirs and methods, the upper section is formed from a material having a thermal conductivity that is no greater than 5 W/m-K.

In embodiments of the thermal reservoirs and methods, the upper section is configured to be connected to a nitrogen feed.

In embodiments of the thermal reservoirs and methods, the upper section is formed from a high density polyethylene.

In an embodiment, a method of processing a material to be melted is provided. The method includes storing a material to be melted in an upper section of a thermal reservoir as described above. The method further includes heating the material within the heating section of the thermal reservoir to a molten state.

In one embodiment, a thermal reservoir including a heating section and an upper section is provided. The upper section defines a storage cavity for storing material to be melted. The upper section is formed from a non-stick material. The upper section is fluidly connected to the heating section and is upstream from the heating section for receiving material prior to the heating section.

In one embodiment, the thermal reservoir includes a nitrogen system for supplying nitrogen to the storage cavity of the upper section.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified cross-section of a portion of a thermal reservoir illustrating the formation of a thin film of hot melt material on a wall thereof;

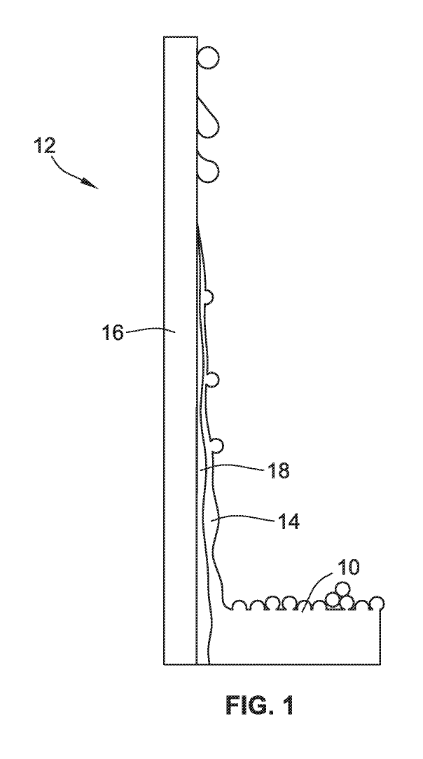

FIG. 2 is a perspective view of an embodiment of a thermal reservoir;

FIG. 3 is a cross-sectional illustration of the thermal reservoir of FIG. 2; and

FIG. 4 is a perspective view of a second embodiment of a thermal reservoir.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

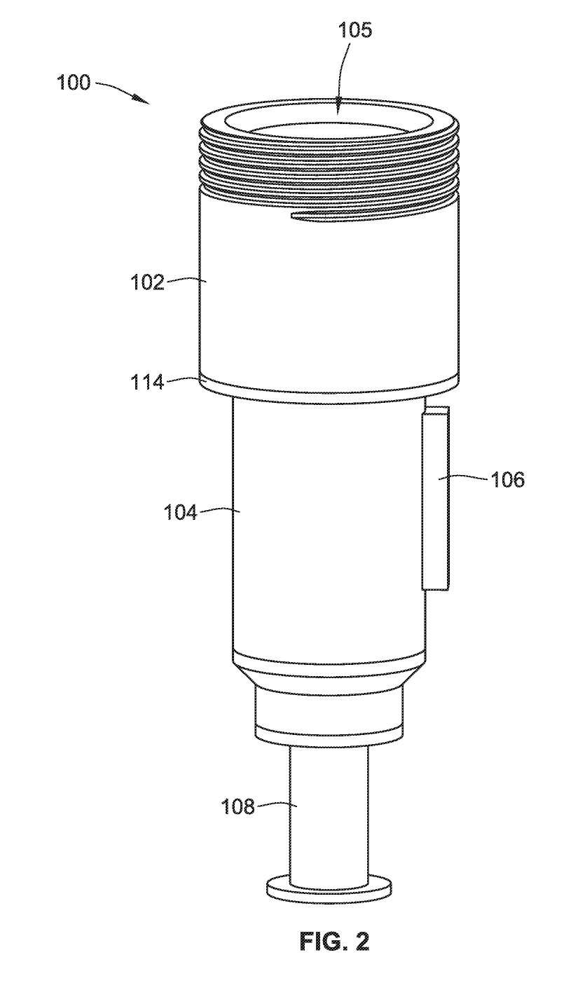

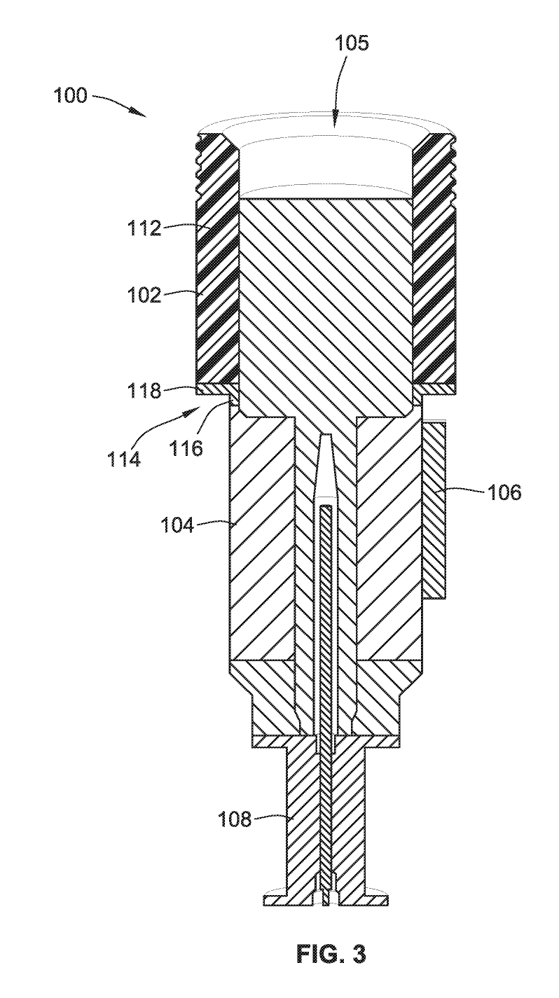

FIGS. 2 and 3 illustrate an improved thermal reservoir 100 for use in systems for processing materials such as hot melt materials or other thermoplastics or thermoplastic like materials. For instance, the thermal reservoir 100 may find use in dispensing systems or molding apparatuses and particularly molding or dispensing apparatuses that mold or dispense hot melt material. While the rest of the description will generally describe the reservoir 100 in terms of a molding apparatus, it is equally applicable to other systems that utilize and heat materials such as dispensing systems. Such a molding apparatus or dispensing system may also be referred to as a hot melt material processor. The thermal reservoir 100 includes an upper section 102 (also referred to an extension section 102) and a lower heating section 104 (also referred to as a finned portion 104).

Hot melt material to be molded will enter the thermal reservoir 100 through the upper section 102. The upper section 102 defines an internal storage cavity 105 for storing large amounts of hot melt material in powder/granular form to be melted.

Hot melt material in powder/granular form will be heated and melted in the finned portion 104 by a heater 106 adjacent to or integrated into the finned portion 104. The heater 106 is illustrated in simplified schematic form in FIGS. 2 and 3 attached to the finned portion 104. In some embodiments, the heater 106 may by tubular and surround a portion of the finned portion 104. The finned portion 104 may include a plurality of fins or flow passages that form webs of material to increase the surface area that is exposed to the hot melt material to increase the melting efficiency and uniformity provided by the thermal reservoir 100.

Typically, the volume for holding hot melt material and structure of finned portion 104 and heater 106 are configured such that the finned portion 104 will hold the desired amount of material within the finned portion 104. The size and configuration of the finned portion 104 will be such that the heater 106 will provide the correct amount of heat to the finned portion 104 to melt the amount of hot melt material flowing through the finned portion 104 per unit of time.

Molten hot melt material will be ejected from ejection end 108.

To avoid the problems identified in the prior art, namely generating a thin film of material and particularly over heating such a thin film of material, the upper section 102 is manufactured in an insulated non-stick material. This allows large amounts of material to be add to the thermal reservoir 100 and eliminates or significantly reduces material melting along the vertical wall 112 of the upper section 102 prior to entering the finned portion 104.

The insulation provided will prevent the wall 112 from heating to a temperature that will melt the hot melt material stored within the upper section 102. By preventing the material from melting, the thin film will not form along the inner surface of wall 112 as the material flows through the upper section 102 toward the finned portion 104. Even if some of the material melts within the upper section 102, the non-stick characteristics will also prevent or inhibit the material from building up on the inner surface of wall 112.

In the illustrated embodiment, the upper section 102 is attached to an adapter plate 114 that connects to the finned portion 104. The adapter plate 114 has a lower flange portion 116 configured to mate to an upper end of the finned portion 104 and an upper flange portion 118 configured to mate with a lower end of the upper section 102.

In some embodiments, the adapter plate 114 may be unitarily formed as a single piece with the finned portion 104.

In one embodiment, the upper section 102 is formed from polytetrafluoroethylene (PTFE) or a similar material, such as Polyetheretherketone (PEEK) or Engineered High Density Polyethylenes (HDPE HD 6909 or Engineered Poly NLT Engineered UHMW). Preferably, the material of the upper section has a thermal conductivity less than 5 W/m-K. Additionally, the material of the upper section should have a co-efficient of friction that is as low as possible but will typically be between 0.03 to 0.5.

The thermal reservoir 100 and particularly the upper end of the upper section 102 may be configured to receive a lid or be connected to a larger bulk supply system for supplying unmelted powder/granular hot melt material.

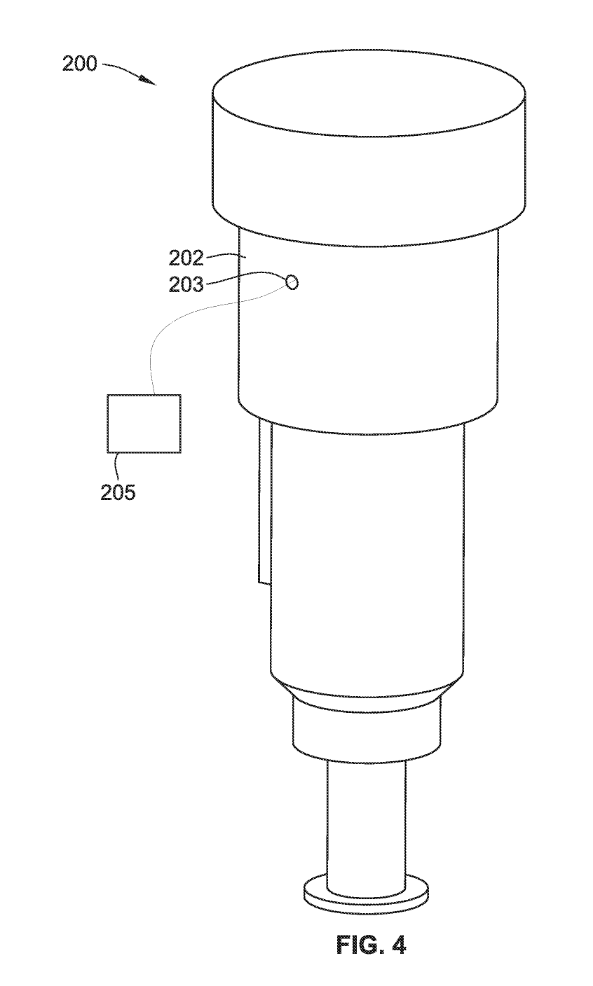

FIG. 4 illustrates an alternative embodiment of a thermal reservoir 200. The thermal reservoir is similar to the prior thermal reservoir 100 in all aspects accept it is configured to accept a nitrogen feed to reduce oxidation of the hot melt material within the system.

The upper section 202 includes port 203 that is operably coupled to a nitrogen feed system 205. Nitrogen is fed into the upper section 202 over the top of any material stored within the thermal reservoir 200. The presence of nitrogen as opposed to air within the upper section 202 will inhibit oxidation.

In both systems, the system may or may not utilize pressure to assist the material feed from the thermal reservoir, e.g. into a pump or plunger.

It should be noted that the upper section 102, 202 need not be entirely formed as an insulated non-stick material. Instead, the upper section 102, 202 could be formed from multiple components such that an inner sleeve that contacts the powder/granular hot melt material is formed from the insulated non-stick material.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A thermal reservoir comprising:
a heating section; and
an upper section defining a storage cavity, the upper section being formed from an insulated non-stick material, the upper section being fluidly connected to the heating section and upstream from the heating section for receiving material prior to the heating section.

2. The thermal reservoir of claim 1, wherein the upper section is formed from polytetrafluoroethylene.

3. The thermal reservoir of claim 1, wherein the heating section is a finned portion defining one or more flow passages therethrough, the one or more flow passages being in fluid communication with the storage cavity.

4. The thermal reservoir of claim 1, wherein the upper section is formed from a material having a thermal conductivity that is no greater than 5 W/m-K.

5. The thermal reservoir of claim 1, wherein the upper section is configured to be connected to a nitrogen feed.

6. The thermal reservoir of claim 1, wherein the upper section is formed from a high density polyethylene.

7. A thermal reservoir comprising:
a heating section; and
an upper section defining a storage cavity, the upper section being formed from an insulated material, the upper section being fluidly connected to the heating section and upstream from the heating section for receiving material prior to the heating section.

8. The thermal reservoir of claim 7, wherein the upper section is formed from polytetrafluoroethylene.

9. The thermal reservoir of claim 7, wherein the heating section is a finned portion defining one or more flow passages therethrough, the one or more flow passages being in fluid communication with the storage cavity.

10. The thermal reservoir of claim 7, wherein the upper section is formed from a material having a thermal conductivity that is no greater than 5 W/m-K.

11. The thermal reservoir of claim 7, wherein the upper section is configured to be connected to a nitrogen feed.

12. The thermal reservoir of claim 7, wherein the upper section is formed from a high density polyethylene.

13. A method of processing a material to be melted comprising:
storing a material to be melted in an upper section of a thermal reservoir of claim 1; and
heating the material within the heating section of the thermal reservoir to a molten state.

14. The method of claim 13, wherein the upper section is formed from polytetrafluoroethylene.

15. The method of claim 13, wherein the heating section is a finned portion defining one or more flow passages therethrough, the one or more flow passages being in fluid communication with the storage cavity.

16. The method of claim 13, wherein the upper section is formed from a material having a thermal conductivity that is no greater than 5 W/m-K.

17. A method of processing a material to be melted comprising:
storing a material to be melted in an upper section of a thermal reservoir of claim 7; and
heating the material within the heating section of the thermal reservoir to a molten state.

18. The method of claim 17, wherein the upper section is formed from polytetrafluoroethylene.

19. The method of claim 17, wherein the heating section is a finned portion defining one or more flow passages therethrough, the one or more flow passages being in fluid communication with the storage cavity.

20. The method of claim 17, wherein the upper section is formed from a material having a thermal conductivity that is no greater than 5 W/m-K.
